(19) United States
(12) Patent Application Publication
(10) Pub. No.: US 2014/0362054 A1
(43) Pub. Date: Dec. 11, 2014

(54) DISPLAY CONTROL SYSTEM AND READING DEVICE

(71) Applicant: Panasonic Corporation, Osaka (JP)

(72) Inventor: Daizaburo MATSUKI, Osaka (JP)

(21) Appl. No.: 14/466,165

(22) Filed: Aug. 22, 2014

Related U.S. Application Data
(63) Continuation of application No. PCT/JP2013/007513, filed on Dec. 20, 2013.

(30) Foreign Application Priority Data
Dec. 28, 2012 (JP) 2012-287108

(51) Int. Cl. G06F 3/0354; G06F 3/041; G06F 3/042

(52) U.S. Cl. CPC G06F 3/03542; G06F 3/0425; G06F 3/0416
USPC 345/175

(57) ABSTRACT

In a display control system, a reading device includes a light source and an imaging optical system configured to capture an image of light, and a display panel includes: an information pattern layer; and a reflection layer configured to diffusely reflect the light from the light source. The light source is arranged at a position other than a position on an optical axis of the imaging optical system. In a state where the optical axis of the imaging optical system is perpendicular to the reflection layer and the reading device is in contact with the display panel, a point at which a central light beam of the light emitted from the light source reaches the reflection layer is located at the light source side of a point at which the optical axis of the imaging optical system intersects the reflection layer.

### BACKGROUND

1. Field

The present disclosure relates to a display control system that optically reads an information pattern formed in a display panel, by means of a reading device.

2. Description of the Related Art

Conventionally, a technique is known in which when characters or the like are written on paper with a pen, the information written on the paper is computerized and transmitted to a server or a terminal (Japanese Laid-Open Patent Publication No. 2007-226577).

In Japanese Laid-Open Patent Publication No. 2007-226577, movement of a pen is detected by reading an information pattern composed of a plurality of dots formed on a paper surface.

### SUMMARY

Meanwhile, in recent years, a system has been developed which enables a handwriting input in which a character or the like is written on a display surface of a display device with a writing tool such as a stylus and the trajectory of the writing tool is displayed on the display surface as it is. It is conceivable that the information pattern reading technique described in Japanese Laid-Open Patent Publication No. 2007-226577 is applied to such a system. However, in the case where information patterns are provided in a display device, as compared to the case where information patterns are provided on a paper surface, the behavior of light for reading an information pattern is complicated, and it is difficult to accurately read the information pattern with the conventional system.

The present disclosure provides a display control system that is effective for improving the accuracy of reading an information pattern formed in a display panel.

A display control system according to the present disclosure includes: a display panel configured to display an image; and a reading device configured to optically read an information pattern formed in the display panel. The reading device includes: at least one light source configured to emit light toward the display panel; and an imaging optical system configured to capture an image of the light that has been emitted from the light source and reflected by the display panel. The display panel includes: an information pattern layer in which the information pattern is formed; and a reflection layer arranged at a back side of the information pattern layer and configured to diffusely reflect the light from the light source. The light source is arranged at a position other than a position on an optical axis of the imaging optical system. In a perpendicular contact state where the optical axis of the imaging optical system is perpendicular to the reflection layer and the reading device is in contact with the display panel, a point at which a central light beam of the light emitted from the light source reaches the reflection layer is located at the light source side of a point at which the optical axis of the imaging optical system intersects the reflection layer.

In addition, a reading device according to the present disclosure is a reading device for optically reading an information pattern in a display panel including: an information pattern layer in which the information pattern is formed; and a reflection layer arranged at a back side of the information pattern layer and configured to diffusely reflect light. The reading device includes: at least one light source configured to emit light toward the display panel; and an imaging optical system configured to capture an image of the light that has been emitted from the light source and reflected by the display panel. The light source is arranged at a position other than a position on an optical axis of the imaging optical system. In a state where the optical axis of the imaging optical system is perpendicular to the reflection layer and the reading device is in contact with the display panel, a point at which a central light beam of the light emitted from the light source reaches the reflection layer is located at the light source side of a point at which the optical axis of the imaging optical system intersects the reflection layer.

According to the present disclosure, it is effective for improving the accuracy of reading an information pattern.

### BRIEF DESCRIPTION OF THE DRAWINGS

FIG. 1 is a schematic diagram showing a situation where a user uses a display control system 100;

FIG. 2 is a block diagram of the display control system 100;

FIG. 3 is a cross-sectional view of a display panel 24;

FIG. 4 is a cross-sectional view showing a schematic configuration of a digital pen 10;

FIG. 5 is a schematic diagram for explaining a positional relationship between an intersection point xc at which a central light beam Lc of light from an irradiation section 14 reaches a reflection sheet surface 48a and an intersection point xa at which an optical axis A of an objective lens 15a intersects the reflection sheet surface 48a;

FIG. 6 is a schematic diagram for explaining a positional relationship between a diaphragm 18b and a reflected light beam reflected on a panel surface 32a;

FIG. 7 is a schematic diagram showing a modification in the case where two irradiation sections 14 are provided;

FIG. 8 is a schematic diagram for explaining an information pattern 3;

FIG. 9 is a schematic diagram for explaining that information obtained by numeric conversion of the position of a mark 31 is different depending on the position of the mark 31;

FIG. 10 is a flowchart showing flow of a process of the display control system 100;

FIG. 11 is a block diagram of a display control system 200;

FIG. 12 is a flowchart showing flow of a process of the display control system 200; and

FIG. 13 is a schematic diagram showing another example of the information pattern 3.

### DETAILED DESCRIPTION

Hereinafter, embodiments will be described in detail with reference to the drawings as appropriate. However, there will be instances in which detailed description beyond what is necessary is omitted. For example, detailed description of subject matter that is previously well-known, as well as redundant description of components that are substantially the same will in some cases be omitted. This is to prevent the following description from being unnecessarily lengthy, in order to facilitate understanding by a person of ordinary skill in the art.

The inventor provides the following description and the accompanying drawings in order to allow a person of ordinary skill in the art to sufficiently understand the present disclosure, and the description and the drawings are not intended to restrict the subject matter of the scope of the patent claims.

### Embodiment 1

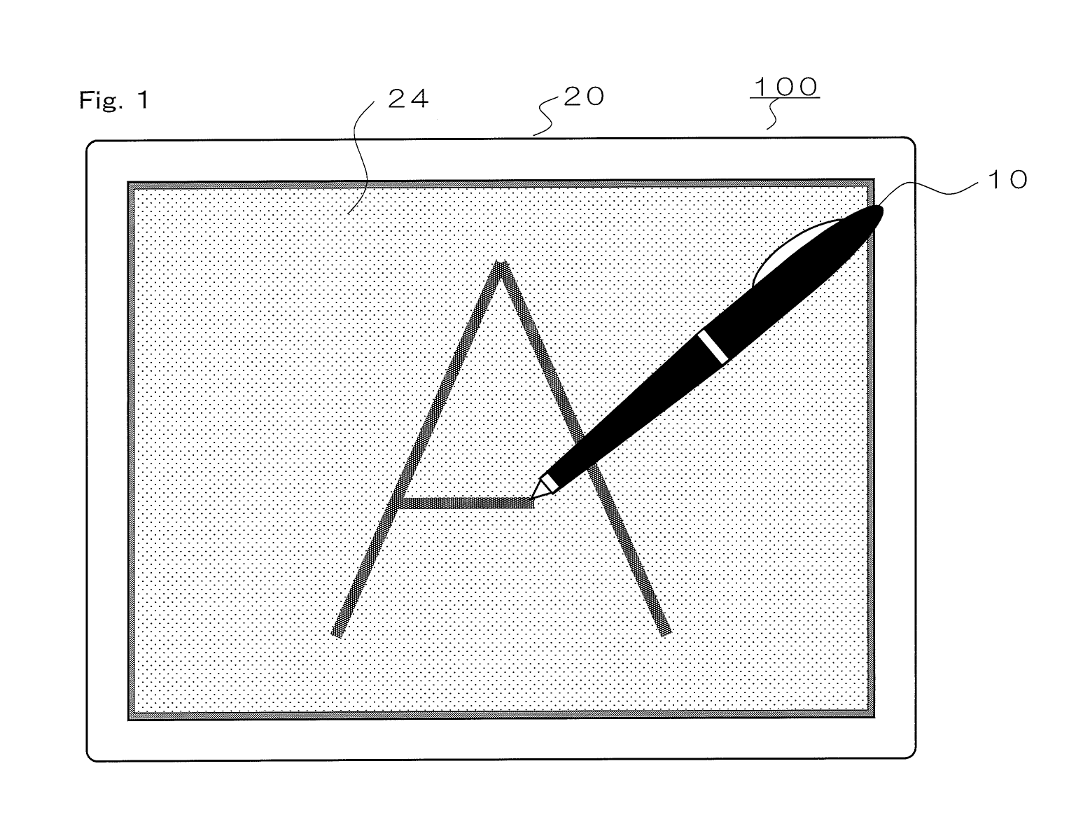

Hereinafter, Embodiment 1 will be described with reference to FIGS. 1 to 10.

### 1. Outline of Display Control System

FIG. 1 is a schematic diagram showing the appearance of a display control system 100 according to Embodiment 1. The display control system 100 includes an optical digital pen (hereinafter, referred to merely as “digital pen”) 10 and a display device 20. The digital pen 10 is an example of a reading device.

Although described in detail later, the display device 20 is a liquid crystal display capable of displaying various images on a display surface of a display panel 24 (a display section). In addition, the display device 20 is provided with information patterns 3 (dot patterns) each representing information regarding a position on the display surface of the display panel 24. The information patterns 3 are provided so as to overlap the display surface of the display panel 24 in a front view of the display panel 24. The digital pen 10 detects information regarding a position of the tip of the digital pen 10 on the display surface of the display panel 24 (hereinafter, also referred to as “position information”) by optically reading the information pattern 3, and transmits the position information to the display device 20. The display device 20 receives the position information as an input and performs various display control.

For example, when the tip of the digital pen 10 is moved on the display panel 24, the digital pen 10 detects continuous position information as a trajectory of the tip of the digital pen 10 from continuously read information patterns 3. The display device 20 continuously displays spots on the display panel 24 in accordance with the trajectory of the tip of the digital pen 10. By so doing, it is possible to perform a handwriting input of a character, a figure, or the like on the display panel 24 by using the digital pen 10. Or the display device 20 continuously deletes spots displayed on the display panel 24, in accordance with the trajectory of the tip of the digital pen 10. By so doing, it is possible to delete a character or a figure on the display panel 24 by using the digital pen 10 like an eraser. In other words, the digital pen 10 serves as a reading device and also serves as an input device that performs an input to the display control system 100.

### 2. Configuration of Display Device

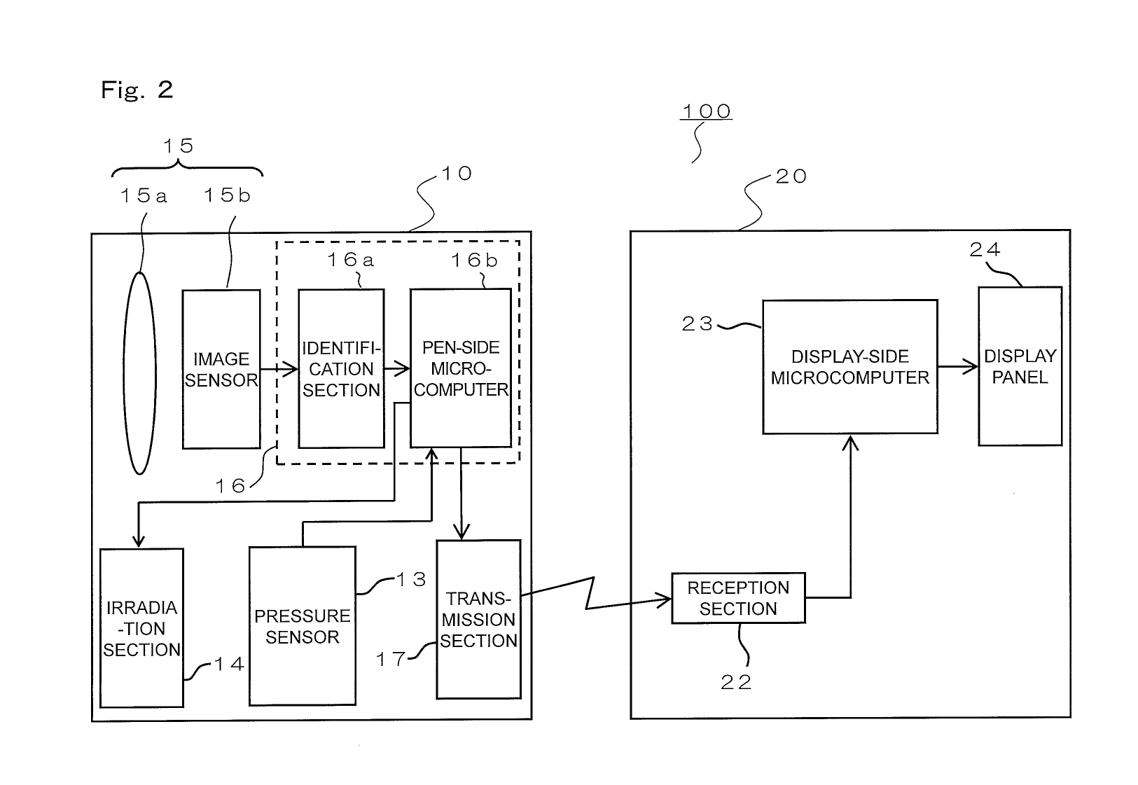

Hereinafter, the display device 20 will be described. FIG. 2 is a block diagram showing a schematic configuration of the display control system 100.

The display device 20 includes a reception section 22 that receives a signal from an external device, a display-side microcomputer 23 that controls the entirety of the display device 20, and the display panel 24 that displays an image.

Although described in detail later, the reception section 22 receives a signal transmitted from the digital pen 10. The signal received by the reception section 22 is transmitted to the display-side microcomputer 23.

The display-side microcomputer 23 is composed of a CPU, a memory, and the like. The display-side microcomputer 23 is provided with a program for causing the CPU to operate. For example, the display-side microcomputer 23 controls the display panel 24 on the basis of a signal transmitted from the digital pen 10 and changes a content displayed on the display panel 24.

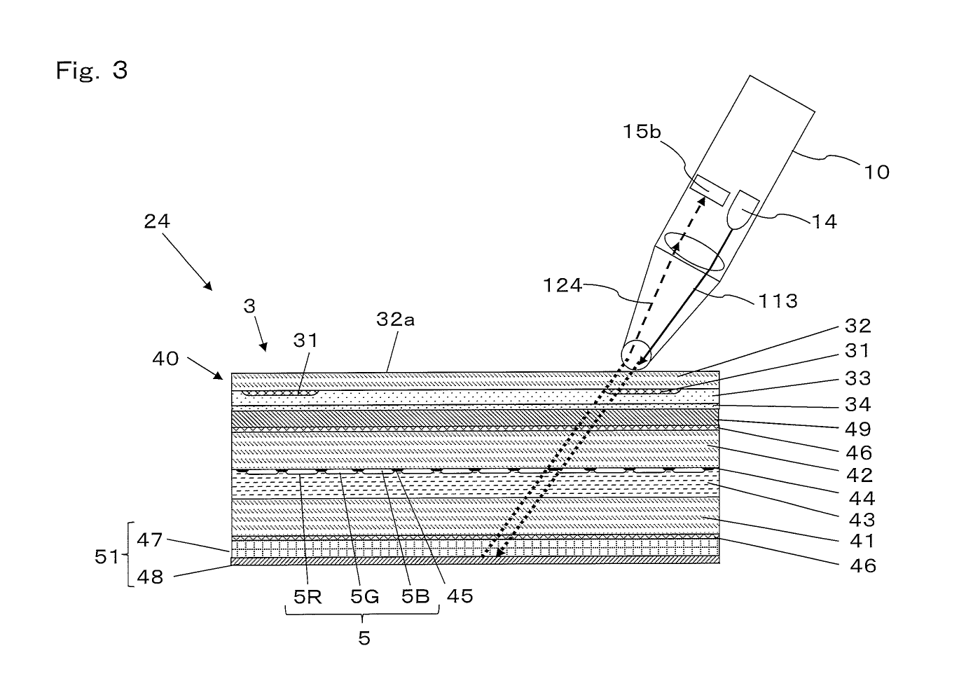

FIG. 3 is a schematic cross-sectional view showing the configuration of the display panel 24 in which the information patterns 3 are arranged. The display panel 24 shown in FIG. 3 is an example of an active matrix type TFT color liquid crystal display panel.

In FIG. 3, the display panel 24 (liquid crystal panel section) is formed by enclosing a liquid crystal member 43 between two substrates 41 and 42 opposed to each other. Each of the substrates 41 and 42 is a plate having optical transparency, and, for example, a glass substrate may be used. It should be noted that although not shown, thin film transistors, which are crystal liquid driving components, a first transparent electrode, a signal electrode, and a scanning electrode are formed on the substrate 41 at the back side (the lower side in FIG. 3) in the display panel 24. In addition, pixels 5 each including at least a red sub-pixel 5R, a green sub-pixel 5G, and a blue sub-pixel 5B, a black matrix 45 that separates the pixels 5 and the sub-pixels 5R, 5G, and 5B, and a second transparent electrode are formed at the back side (the side opposed to the substrate 41) of the substrate 42 at the front side (the upper side in FIG. 3) in the display panel 24. The black matrix 45 is a light shielding member that has openings corresponding to the sub-pixels 5R, 5G, and 5B, is composed of a metal thin film of chromium or the like, and shields the boundary portions between the sub-pixels 5R, 5G, and 5B from light. The pixels 5 and the black matrix 45 are formed on a color filter 44. The enclosed liquid crystal member 43 is arranged between the transparent electrodes formed on the two substrates 41 and 42. In addition, polarizing plates 46 are arranged on outer surfaces of the substrates 41 and 42, respectively. The polarizing plates 46 are attached to the substrates 41 and 42, respectively.

It should be noted that the color filter 44 is not limited to the RGB color filter. Sub-pixels of cyan (C), magenta (M), yellow (Y), or the like may be formed on the color filter 44, or sub-pixels of white (W) may be formed on the color filter 44.

A backlight unit 51 is arranged on a portion at the back side of the display panel 24 (specifically, the lower side of a polarizing plate 46 attached to the substrate 41 at the lower side in FIG. 3). The backlight unit 51 includes a surface light source member 47 and a diffuse reflection sheet 48. In addition, an on-cell type capacitance touch panel 49 is arranged on a portion at the front side of the display panel 24 (specifically, the upper side of a polarizing plate 46 attached to the substrate 42 at the upper side in FIG. 3). It should be noted that the touch panel 49 may be an in-cell type touch panel, or another type of touch panel such as a resistive pressure-sensitive type. Alternatively, the display panel 24 may be configured such that the touch panel 49 is omitted therefrom.

The display panel 24 has a configuration in which a plurality of the pixels 5 each composed of a plurality of the sub-pixels 5R, 5G, and 5B whose colors are different from each other are arranged in a matrix manner. In the display panel 24, ON/OFF of each of thin film transistors for the sub-pixels 5R, 5G, and 5B constituting each pixel 5 is controlled and the polarization of the liquid crystal member 43 is selectively controlled, whereby the display panel 24 is able to perform a color display of a character or an image.

In addition, a plurality of the information patterns 3 (position information patterns) from each of which position information is detected by the digital pen 10 are arranged on the touch panel 49 of the display panel 24. Each information pattern 3 has a plurality of marks 31 (dots). As shown in FIG. 3, the information pattern 3 is configured by forming a plurality of marks 31 having a circular shape, a quadrate shape, or the like in a determined array pattern on a translucent base film 32 made of resin, and forming a translucent resin layer 33 on the base film 32 such that the resin layer 33 covers the plurality of marks 31. The resin layer 33 is a layer for adjusting a refractive index. A laminate of the base film 32 and the resin layer 33 forms an optical film 40 corresponding to an information pattern layer in which the information patterns 3 are formed. In addition, an adhesive layer 34 made of a translucent adhesive material is provided on the resin layer 33. The optical film 40 is attached at its resin layer 33 side on the touch panel 49 by the adhesive layer 34 such that the base film 32 is at the front side.

Each mark 31 in each information pattern 3 is formed from a material that transmits visible light and absorbs infrared light. Thus, it is possible to reduce influence of each mark 31 on a color display image, in the visible light range, which is displayed on the display panel 24.

As shown in FIG. 3, infrared light 113 emitted from the digital pen 10 is applied to the display surface of the display panel 24 that is pointed to by the tip of the digital pen 10. The infrared light 113 applied to the display surface passes through the display panel 24, reaches the diffuse reflection sheet 48, and is diffusely reflected on the diffuse reflection sheet 48. Thus, part of the infrared light 113 is reflected toward the digital pen 10 side. Infrared light 124 reflected toward the digital pen 10 side passes through a region where the information pattern 3 is formed. At that time, in the information pattern 3, the infrared light 124 is absorbed in a region where each mark 31 is arranged, and the infrared light 124 is transmitted in a region where no mark 31 is arranged. Thus, the infrared light 124 incident on the digital pen 10 is received by a reading section 15 and the information pattern 3 is read therefrom, whereby it is possible to detect position information (coordinate information) represented by the marks 31 formed in the information pattern 3.

### 3. Configuration of Digital Pen

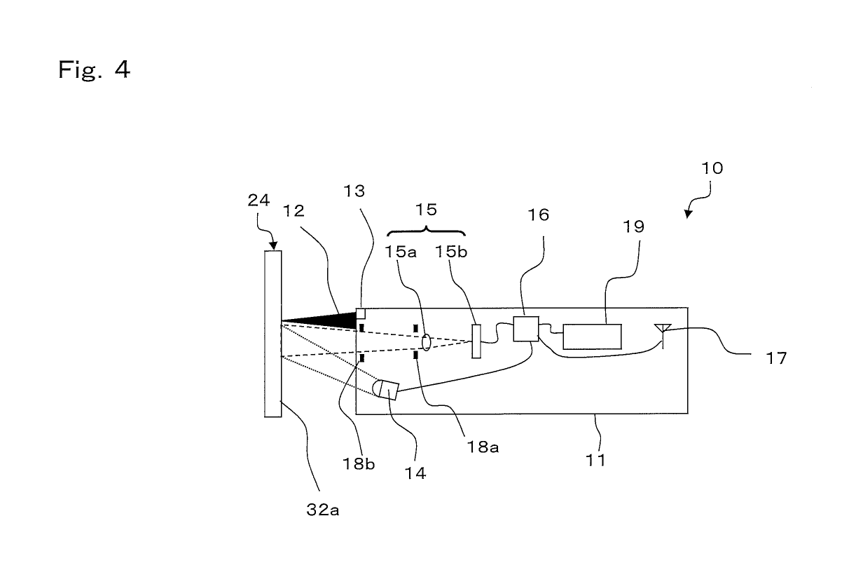

Next, a detailed configuration of the digital pen 10 will be described. FIG. 4 is a cross-sectional view showing a schematic configuration of the digital pen 10.

The digital pen 10 includes a cylindrical body case 11, a pen tip portion 12 that is attached to a tip end of the body case 11, a pressure sensor 13 that detects a pressure applied to the pen tip portion 12, an irradiation section 14 that emits infrared light, a reading section 15 that optically reads infrared light incident thereon, a control section 16 that controls the digital pen 10, a transmission section 17 that outputs a signal to an external device, and a power supply 19 that supplies power to each component of the digital pen 10. In addition, the digital pen 10 includes a diaphragm 18a and a diaphragm 18b for limiting an amount of light incident on the reading section 15. The diaphragm 18a and the diaphragm 18b will be described in detail later.

The body case 11 has an outer shape similar to that of a general pen and is formed in a cylindrical shape. The pen tip portion 12 is formed in a tapered shape. The tip of the pen tip portion 12 is rounded to such an extent that the tip does not damage the surface of the display panel 24. In addition, the pen tip portion 12 preferably has such a shape that the user is allowed to easily recognize an image displayed on the display panel 24.

The pressure sensor 13 is provided within the body case 11 and is connected to a base portion of the pen tip portion 12. The pressure sensor 13 detects a pressure applied to the pen tip portion 12 and transmits the detection result to the control section 16. Specifically, the pressure sensor 13 detects a pressure applied from the display panel 24 to the pen tip portion 12 when the user writes a character or the like on the display panel 24 with the digital pen 10. In other words, the pressure sensor 13 is used when it is determined whether the user intends to perform an input with the digital pen 10.

The irradiation section 14 is provided in a tip end portion of the body case 11 and, for example, near the pen tip portion 12. The irradiation section 14 is composed of, for example, an infrared LED. The irradiation section 14 is provided so as to emit infrared light from the tip end of the body case 11.

The reading section 15 includes an objective lens 15a and an image sensor 15b. The objective lens 15a causes light, incident thereon from the pen tip side, to form an image on the image sensor 15b. The objective lens 15a is provided at the tip end side of the body case 11. Here, when infrared light is emitted from the irradiation section 14 in a state where the tip of the digital pen 10 is directed to the display surface of the display device 20, the infrared light passes through the display panel 24 and is diffusely reflected on the diffuse reflection sheet 48 located at the back side of the display panel 24. As a result, regardless of the angle of the digital pen 10, part of the infrared light having passed through the display panel 24 returns to the digital pen 10 side. The infrared light that has been emitted from the irradiation section 14 and diffusely reflected on the diffuse reflection sheet 48 is incident on the objective lens 15a. The image sensor 15b is provided on the optical axis of the objective lens 15a (i.e., on the optical axis of an imaging optical system). The image sensor 15b converts an optical image formed on an imaging surface thereof to an electrical signal to generate an image signal, and outputs the image signal to the control section 16. The image sensor 15b is composed of, for example, a CCD image sensor or a CMOS image sensor. Although described in detail later, each information pattern 3 is formed from a material that absorbs infrared light (a material having a low transmittance for infrared light). Thus, almost no infrared light returns from the marks 31 of the information pattern 3 to the digital pen 10. On the other hand, a more amount of infrared light returns from the region between each mark 31 than from the region of each mark 31. As a result, an optical image in which the pattern shape of the information pattern 3 is represented in black is captured by the image sensor 15b.

As shown in FIG. 2, the control section 16 includes an identification section 16a and a pen-side microcomputer 16b. The identification section 16a identifies position information of the digital pen 10 on the display panel 24 on the basis of an image signal from the reading section 15. Specifically, the identification section 16a obtains the pattern shape of the information pattern 3 from an image signal obtained from the reading section 15, and identifies a position of the pen tip portion 12 on the display panel 24 on the basis of the pattern shape. Position information regarding the position of the pen tip portion 12 that is identified by the identification section 16a is transmitted to the transmission section 17 via the pen-side microcomputer 16b. The pen-side microcomputer 16b controls the entirety of the digital pen 10. The pen-side microcomputer 16b is composed of a CPU, a memory, and the like and is provided with a program for causing the CPU to operate.

The transmission section 17 transmits a signal to an external device. Specifically, the transmission section 17 wirelessly transmits the position information identified by the identification section 16a, to an external device. The transmission section 17 performs short-distance wireless communication with the reception section 22 of the display device 20. The transmission section 17 is provided in an end portion of the body case 11 that is opposite to the pen tip portion 12.

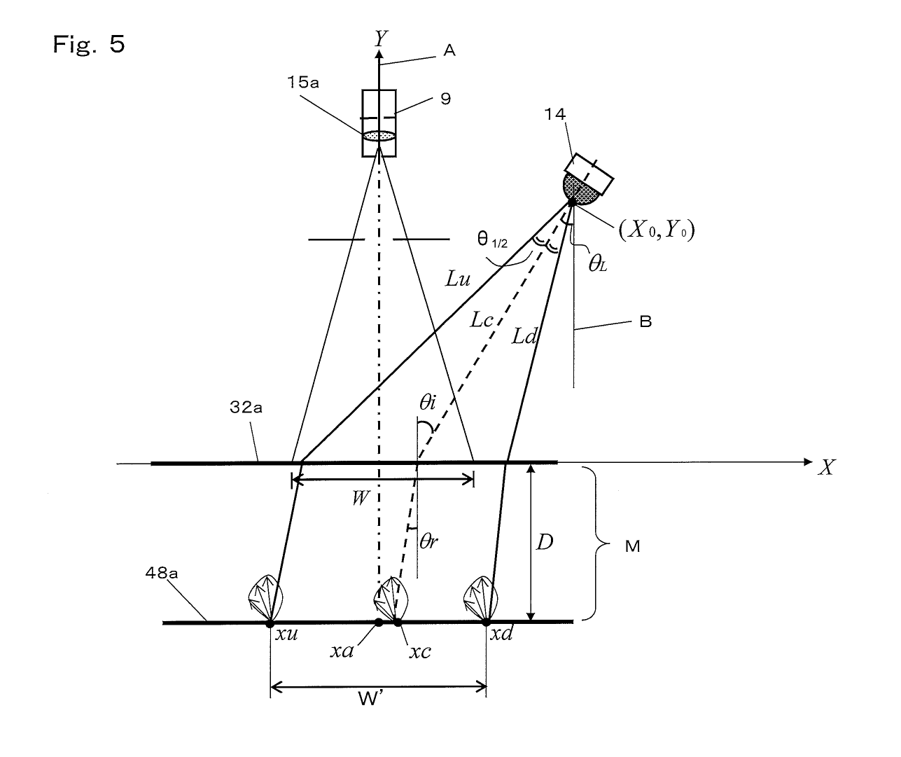

FIG. 5 is a schematic diagram for explaining a positional relationship between an intersection point xc at which a central light beam Lc of light from the irradiation section 14 reaches a reflection sheet surface 48a and an intersection point xa at which the optical axis A of the objective lens 15a intersects the reflection sheet surface 48a.

The light emitted from the irradiation section 14 which is a light source enters through a panel surface 32a into a laminate module M composed of components from the base film 32 to the surface light source member 47, of the display panel 24, and is diffusely reflected on the reflection sheet surface 48a. The panel surface 32a is the outermost surface of the base film 32 shown in FIG. 3, namely, the outermost surface of the display panel 24. The reflection sheet surface 48a is a surface of the diffuse reflection sheet 48 shown in FIG. 3. The panel surface 32a and the reflection sheet surface 48a (the sheet surface of the diffuse reflection sheet 48) are parallel to each other. It should be noted that the laminate module M is composed of a plurality of components as shown in FIG. 3, but, in FIG. 5, for easy explanation, only the panel surface 32a and the reflection sheet surface 48a are shown.

The optical film 40 (not shown in FIG. 5) is arranged between the panel surface 32a and the reflection sheet surface 48a, as an information pattern layer in which the information patterns 3 are formed.

In the present embodiment, the irradiation section 14 is spaced apart from the optical axis A of the objective lens 15a. In other words, the irradiation section 14 is arranged at a position other than a position on the optical axis A of the imaging optical system. In addition, the direction of the central light beam Lc of the light emitted from the irradiation section 14 is tilted relative to the optical axis A of the objective lens 15a. FIG. 5 shows a perpendicular contact state where the tip of the pen tip portion 12 of the digital pen 10 is in contact with the panel surface 32a such that the optical axis A is perpendicular to the panel surface 32a and the reflection sheet surface 48a. In the perpendicular contact state, the intersection point xc at which the central light beam Lc of the light emitted from the irradiation section 14 is refracted by the laminate module M and reaches the reflection sheet surface 48a is present at the X-axis positive direction side of the intersection point xa at which the optical axis A intersects the reflection sheet surface 48a. In other words, on the reflection sheet surface 48a, the intersection point xc is located at the irradiation section 14 side of the intersection point xa. Due to such a configuration, it is possible to improve the accuracy of reading the information pattern 3.

Hereinafter, a detailed description will be given. First, a definition of a coordinate system used in FIG. 5 will be described.

In FIG. 5, the right-left direction is defined as an X-axis direction (the right side is the positive side, and the left side is the negative side), and the up-down direction is defined as a Y-axis direction (the upper side is the positive side, and the lower side is the negative side). In FIG. 5, the optical axis A of the objective lens 15a coincides with the Y axis, and the panel surface 32a coincides with the X axis. The intersection of the optical axis A and the panel surface 32a is the origin of an XY coordinate system.

The coordinate of the light emission center of the irradiation section 14 is denoted by (X₀,Y₀), the central light beam of the light emitted from the irradiation section 14 is denoted by Lc, the angle formed between the central light beam Lc and a line segment B extending in the Y-axis direction from the light emission center (X₀,Y₀) of the irradiation section 14 (i.e., the tilt angle of the irradiation section 14 with respect to the panel surface 32a) is denoted by θL, and a half-value angle is denoted by θ_{1/2}. The half-value angle is an angle at which, where a light intensity on the axis of the light source (the light intensity of the central light beam Lc of the irradiation section 14 in FIG. 5) is 1, the ratio of the intensity of light viewed from the direction titled relative to the light source at an angle θ is 0.5. It should be noted that a clockwise direction centered at the light emission center (X₀,Y₀) corresponds to the plus direction for the angle.

A module thickness D is the thickness of the laminate module M in the Y-axis direction, namely, the distance from the panel surface 32a to the reflection sheet surface 48a. In this case, the equivalent refractive index of the laminate module M is denoted by n. The equivalent refractive index n is a refractive index when the laminate module M is assumed as a single component, and it is assumed that a light beam travels straight within the laminate module M.

In addition, an imaging range, on the panel surface 32a, of the digital pen 10 in the perpendicular contact state is denoted by W. In FIG. 5, a range in the X-axis direction is indicated as the imaging range W.

The light beam emitted from the irradiation section 14 is mainly applied to an angle range of the half-value angle ±θ_{1/2} with the central light beam Lc having the tilt angle θL as a center. The light beam angle of a light beam (referred to as upper light beam Lu) indicated by a plus-side half-value angle with respect to the central light beam Lc is θL+θ_{1/2}, and the light beam angle of a light beam (referred to as lower light beam Ld) indicated by a minus-side half-value angle with respect to the central light beam Lc is θL−θ_{1/2}.

Schematically, as shown in FIG. 5, the central light beam Lc is refracted at the panel surface 32a at a refraction angle determined based on the equivalent refractive index n or the like, according to the Snell's law, travels straight within the laminate module M, and is diffusely reflected on the reflection sheet surface 48a. It should be noted that in practical, within the laminate module M, light travels straight in a region where the refractive index is constant, and light is refracted at an interface at which the refractive index is changed.

Here, where the incident angle of the light beam when the light beam is refracted at the panel surface 32a is denoted by θi and the refraction angle thereof is denoted by θr, the X coordinate xc of the position at which the central light beam Lc reaches the reflection sheet surface 48a is represented by the following mathematical formulas (1) to (3).

θi=θL, sin θi=n×sin θr (1)

xc=X0−Y0×tan θL−D×tan θr (2)

xc=X0−Y0×tan θL−D×tan(sin⁻¹(sin θL/n)) (3)

Similarly, the X coordinate xu of a position at which the upper light beam Lu reaches the reflection sheet surface 48a is represented by the following mathematical formulas (4) to (6).

θi=θL+θ_{1/2}, sin θi=n×sin θr (4)

xu=X0−Y0×tan(θL+θ_{1/2})−D×tan θr (5)

xu=X0−Y0×tan(θL+θ_{1/2})−D×tan(sin⁻VθL+θ_{1/2})/n)) (6)

The X coordinate xd of a position at which the lower light beam Ld reaches the reflection sheet surface 48a is represented by the following mathematical formulas (7) to (9).

θi=θL−θ_{1/2}, sin θi=n×sin θr (7)

xd=X0−Y0×tan(θL−θ_{1/2})−D×tan θr (8)

xd=X0−Y0×tan(θL−θ_{1/2})−D×tan(sin⁻((θL−θ_{1/2})/n)) (9)

Therefore, a main illumination range W′ in the X-axis direction on the reflection sheet surface 48a (the range from a point xu at which the upper light beam Lu reaches the reflection sheet surface 48a to a point xd at which the lower light beam Ld reaches the reflection sheet surface 48a) is represented by the following mathematical formula (10).

$$\begin{matrix}{W}^{′} = xd - xu \\ = Y 0 \times ( tan ( θ L - {θ}_{1 / 2} ) - tan ( θ L + {θ}_{1 / 2} ) ) + D \times \\ ( tan ( {sin}^{- 1} ( ( θ L - {θ}_{1 / 2} ) / n ) - {sin}^{- 1} ( ( θ L + {θ}_{1 / 2} ) / n ) )\end{matrix} \qquad ( 10 )$$

In general, if illumination unevenness is smaller and the illumination is brighter in the imaging range, the recognition rate of the information pattern 3 is higher, and the coordinate detection rate is increased accordingly.

The display control system 100 of the present embodiment is configured such that the X coordinate xc representing the position where the central light beam Lc reaches meets a condition of xc>0. Here, perfect diffusion does not occur on the reflection sheet surface 48a, and in practical, reflected light includes a specular reflection component. Thus, the reflected light has relatively strong directivity at the minus side in the X-axis direction, unlike a Lambert light source. The light beam reflected and diffused on the reflection sheet surface 48a further travels straight within the laminate module M, is refracted at the panel surface 32a, and is emitted from the laminate module M. At that time, on the panel surface 32a, an illumination distribution is provided in which the minus side in the X-axis direction of the X coordinate xc is relatively bright and the plus side in the X-axis direction of the X coordinate xc is further relatively dark. Therefore, when the configuration that meets the condition of xc>0 is provided, namely, when the X coordinate xc is set at the plus side in the X-axis direction of the center of the imaging range W, it is possible to suppress illumination unevenness in the imaging range W.

Here, the case with xc≦0 will be described. In the case with xc≦0, on the panel surface 32a, whereas the minus side in the X-axis direction of the X coordinate xc is relatively bright, the brightest illumination distribution is out of the imaging range W, and a illumination distribution is provided in which the plus side in the X-axis direction of the X coordinate xc is relatively dark. Therefore, in the case with xc≦0, illumination unevenness is likely to occur in the imaging range W, and the recognition rate of the information pattern 3 is decreased, and the coordinate detection rate is decreased accordingly.

It should be noted that the condition of xc>0 is met for the central wavelength of the light emitted from the irradiation section 14. For example, the irradiation section 14 emits infrared light having a central wavelength of 850 nm or higher. In addition, the condition of xc>0 is met, for example, even in a state where the optical axis of the objective lens 15a is tilted relative to the reflection sheet surface 48a at 45 degrees and the tip of the pen tip portion 12 of the digital pen 10 is in contact with the surface of the display panel 24.

Furthermore, the main illumination range W′ on the reflection sheet surface 48a desirably meets a condition of W<W′ (i.e., the main illumination range W′ on the reflection sheet surface 48a is wider than the imaging range W). Due to such a configuration, the width of the distribution of the light reflected diffusely on the reflection sheet surface 48a is increased. As a result, in the imaging range W, illumination unevenness is further reduced, thus the recognition rate of the information pattern 3 is high, and the coordinate detection rate is further increased accordingly.

Reversely, if W<W′, the width of the distribution of the light reflected diffusely on the reflection sheet surface 48a is decreased. As a result, in the imaging range W, illumination unevenness is likely to occur, and the recognition rate of the information pattern 3 is decreased, and the coordinate detection rate is decreased accordingly.

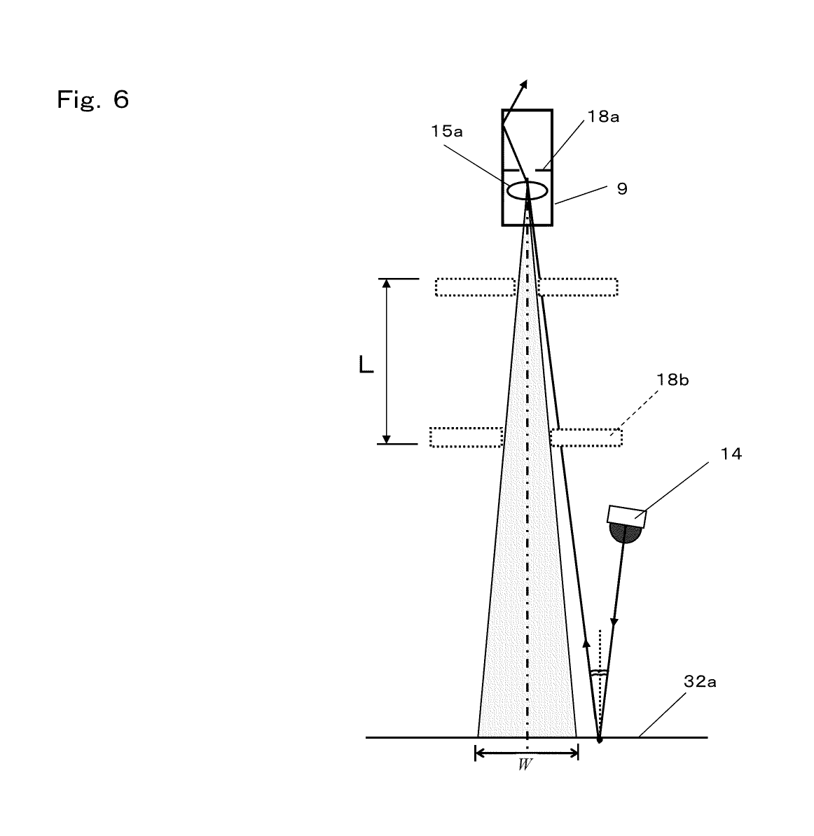

FIG. 6 is a schematic diagram showing a positional relationship between the diaphragm 18b and a reflection component generated on the panel surface 32a.

As shown in FIG. 6, in the present embodiment, the diaphragm 18a for limiting an amount of light is provided within a lens barrel 9. Besides the diaphragm 18a, the diaphragm (opening member: aperture) 18b for controlling a view angle is provided. It should be noted that in FIG. 6, for facilitating the explanation of the light beam, the diaphragm 18b is shown by a dotted line. In addition, the diaphragm 18b can be provided at any position in a range indicated by a dimension line L in FIG. 6. The size of the opening of the diaphragm 18b may be changed as appropriate in accordance with the position at which the diaphragm 18b is arranged. Here, on the panel surface 32a, in general, a reflection component generated at a position sufficiently away from the imaging range W does not travel toward the lens barrel 9 and thus is not problematic. However, in the present embodiment, there is the possibility of use under such a condition that the central light beam Lc is reflected at a position that is near the outer periphery of the imaging range W and out of the imaging range W. Without the diaphragm 18b, as shown in FIG. 6, the reflection component generated thus travels from the panel surface 32a toward the lens barrel 9 and is reflected or diffused within the lens barrel 9. Accordingly, a ghost or flare occurs and becomes an error factor in reading the information pattern 3. As a result, the coordinate detection rate in the digital pen 10 is considerably decreased.

In the present embodiment, the opening member 18b (aperture) for controlling a view angle is provided. The position and the tilt of the irradiation section 14 can be set with respect to the opening member 18b such that the central light beam Lc of the light from the irradiation section 14 does not enter into the lens barrel 9. Thus, it is possible to suppress occurrence of a ghost or flare due to a light beam from outside a view angle being reflected or diffused within the lens barrel 9. Furthermore, with the opening member 18b, it is possible to provide an effect of simultaneously suppressing also occurrence of a ghost or flare due to reflected light that has been emitted from the irradiation section 14 and reflected on the pen tip portion 12.

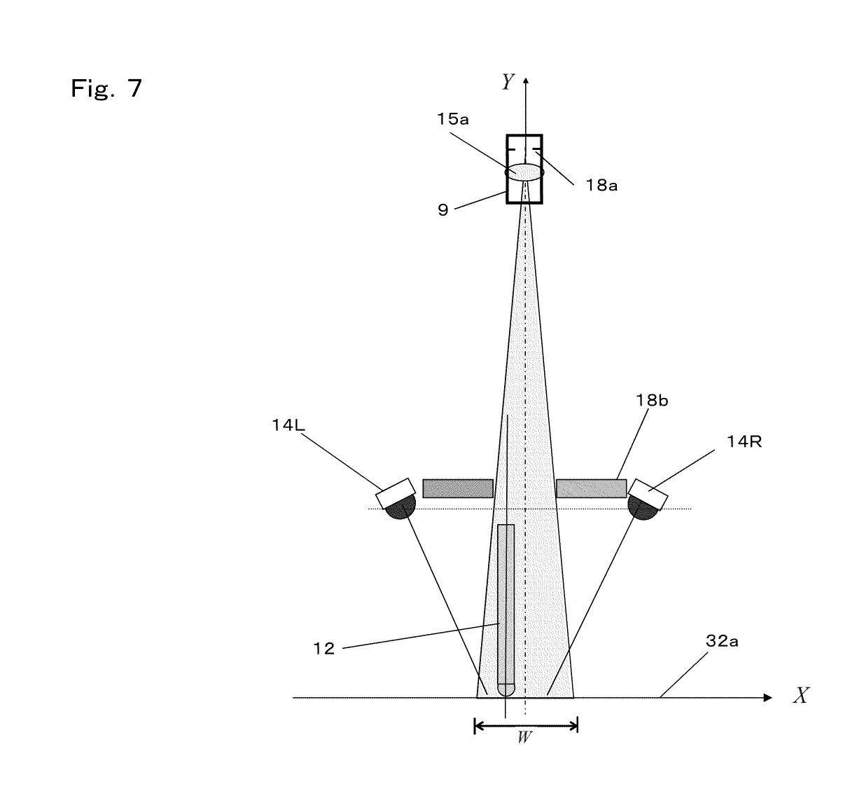

FIG. 7 shows a modification of the present embodiment. The digital pen 10 in FIG. 7 is different from the configuration shown in FIG. 5, in that two light sources, namely, an R-side irradiation section 14R and an L-side irradiation section 14L, are arranged.

As shown in FIG. 7, the position of the center of the tip of the pen tip portion 12 and the position of the center of the imaging range W on the panel surface 32a may be different from each other. In other words, the position of the center of the tip of the pen tip portion 12 may be deviated from the optical axis of the objective lens 15a. In addition, the R-side irradiation section 14R and the L-side irradiation section 14L may be arranged asymmetrically about the optical axis of the objective lens 15a. Furthermore, the tilt angles θL of the R-side irradiation section 14R and the L-side irradiation section 14L may be different from each other.

The opening of the diaphragm 18b for controlling a view angle is located at the plus side in the Y-axis direction of the R-side irradiation section 14R and the L-side irradiation section 14L and at the minus side in the Y-axis direction of the lens barrel 9.

There is a case where a light beam from the R-side irradiation section 14R is reflected on the panel surface 32a, a captured image is saturated with excessive brightness, and accordingly coordinate detection cannot be performed. In such a case, the irradiation section 14 to be used is switched from the R-side irradiation section 14R to the L-side irradiation section 14L, and illumination is performed by the L-side irradiation section 14L. At that time, since a reflection condition angle for the L-side irradiation section 14L is different from that for the R-side irradiation section 14R, a captured image is not saturated in each of the case of illumination by the R-side irradiation section 14R and the case of illumination by the L-side irradiation section 14L, and coordinate detection can be performed at any pen angle.

It should be noted that in the present embodiment, the case where the two irradiation sections 14 are arranged is shown, but at least one irradiation section 14 desirably meets the aforementioned condition (xc>0).

### 4. Details of Information Patterns

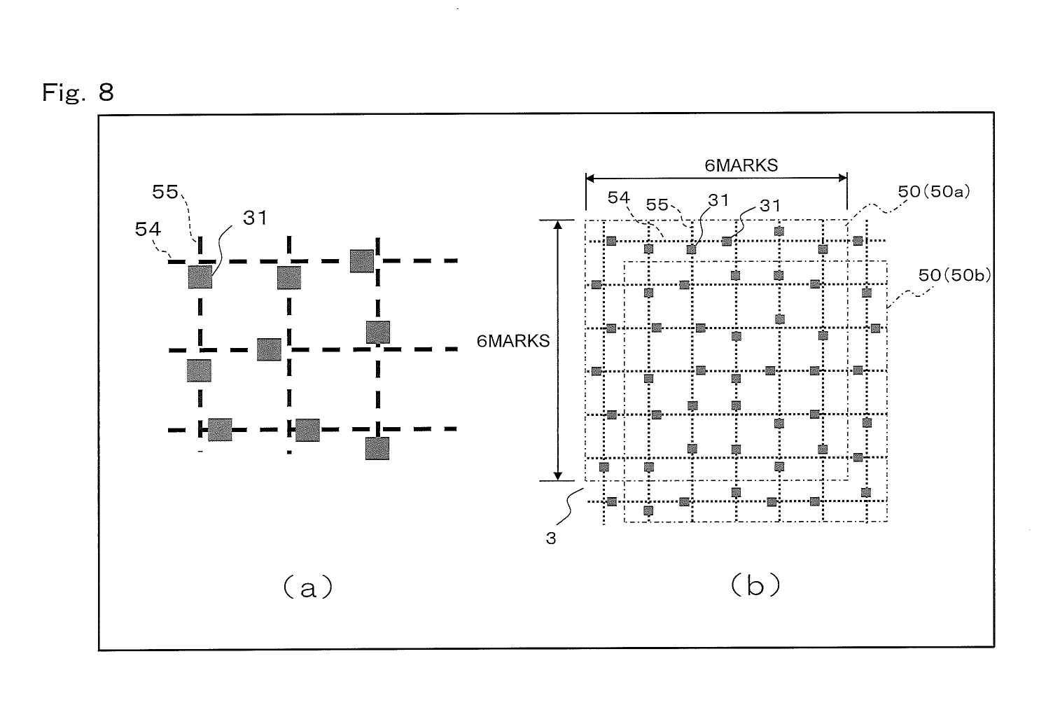

FIG. 8 is a diagram showing an arrangement pattern of each mark 31. In FIG. 8, for explaining the position of each mark 31, first reference lines 54 and second reference lines 55 are shown as virtual lines (lines that do not actually exist). The first reference lines 54 and the second reference lines 55 are perpendicular to each other. In FIG. 8, a grid is formed of a plurality of the first reference lines 54 arranged, for example, at equal intervals and a plurality of the second reference lines 55 arranged, for example, at equal intervals.

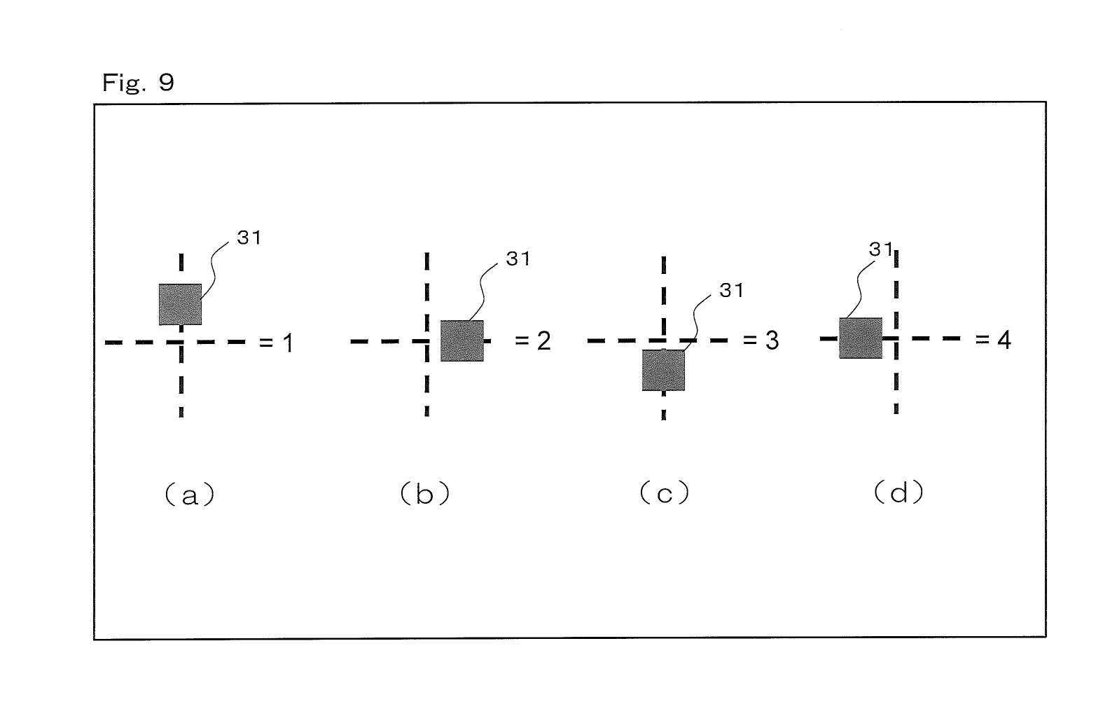

Each mark 31 is arranged at a position shifted (off-set) from the intersection of the first reference line 54 and the second reference line 55 in any of four directions along the direction in which the first reference line 54 extends and the direction in which the second reference line 55 extends. Specifically, each mark 31 is arranged as shown in any of (a) to (d) of FIG. 9. In the arrangement of (a) of FIG. 9, the mark 31 is arranged at a position above the intersection of the first reference line 54 and the second reference line 55. This arrangement is represented by “1” when numeric conversion is performed thereon. In the arrangement of (b) of FIG. 9, the mark 31 is arranged at a position on the right side of the intersection of the first reference line 54 and the second reference line 55. This arrangement is represented by “2” when numeric conversion is performed thereon. In the arrangement of (c) of FIG. 9, the mark 31 is arranged at a position below the intersection of the first reference line 54 and the second reference line 55. This arrangement is represented by “3” when numeric conversion is performed thereon. In the arrangement of (d) of FIG. 9, the mark 31 is arranged at a position on the left side of the intersection of the first reference line 54 and the second reference line 55. This arrangement is represented by “4” when numeric conversion is performed thereon. Each mark 31 is represented by a number of “1” to “4” in the digital pen 10 in accordance with the arrangement pattern.

Then, as shown in (b) of FIG. 8, 6 marks×6 marks are set as one unit area 50, and one information pattern 3 is formed of the 36 marks 31 included in a unit area 50. By arranging each of the 36 marks 31, included in each unit area 50, at any of “1” to “4” shown in FIG. 9, it is possible to form a huge number of the information patterns 3 having information different from each other. All the information patterns 3 on the optical film 40 are different from each other.

Information is added to each of these information patterns 3. Specifically, each information pattern 3 represents a position coordinate of each unit area 50. In other words, when the optical film 40 is divided in the unit areas 50 of 6 marks×6 marks, the information pattern 3 in each unit area 50 represents a position coordinate of the unit area 50. In (b) of FIG. 8, an information pattern 3 in an area 50a represents a position coordinate of the center position of the area 50a, and an information pattern 3 in an area 50b represents a position coordinate of the center position of the area 50b. When the pen tip moves diagonally downward right in (b) of FIG. 8, an area 50 read by the digital pen 10 is changed from the area 50a to the area 50b. As the method for patterning (coding) and coordinate transformation (decoding) of such an information pattern 3, for example, a publicly known method disclosed in Japanese Laid-Open Patent Publication No. 2006-141061 may be used.

### 5. Material of Marks

Each mark 31 is formed from a material that transmits visible light (light having a wavelength of 400 to 700 nm) and absorbs infrared light (light having a wavelength of 700 nm or longer). Each mark 31 is formed from, for example, a material that absorbs infrared light having a wavelength of 800 nm or longer. Specifically, each mark 31 is formed from a material having a transmittance of 90% or higher for visible light and a transmittance of 50% or lower (e.g., 20% or lower) for infrared light. For example, each mark 31 may be formed from a material having a transmittance of 10% for infrared light.

Examples of such materials include diimmonium-based compounds, phthalocyanine-based compounds, and cyanine-based compounds. These materials may be used singly or may be mixed and used. A diimmonium salt-based compound is preferably included as a diimmonium-based compound. The diimmonium salt-based compound has a large amount of absorption in the near-infrared range, has a wide range of absorption, and has a high transmittance for light in the visible light range. As the diimmonium salt-based compound, a commercially available product may be used, and, for example, KAYASORB series (Kayasorb IRG-022, IRG-023, IRG-024, etc.) manufactured by Nippon Kayaku Co., Ltd. and CIR-1080, CIR-1081, CIR-1083, CIR-1085, etc. manufactured by Japan Carlit Co., Ltd. are preferred. As a cyanine-based compound, a commercially available product may be used, and, for example, TZ series (TZ-103, TZ-104, TZ-105, etc.) manufactured by ADEKA Corporation and CY-9, CY-10, etc. manufactured by Nippon Kayaku Co., Ltd. are preferred.

### 6. Operation

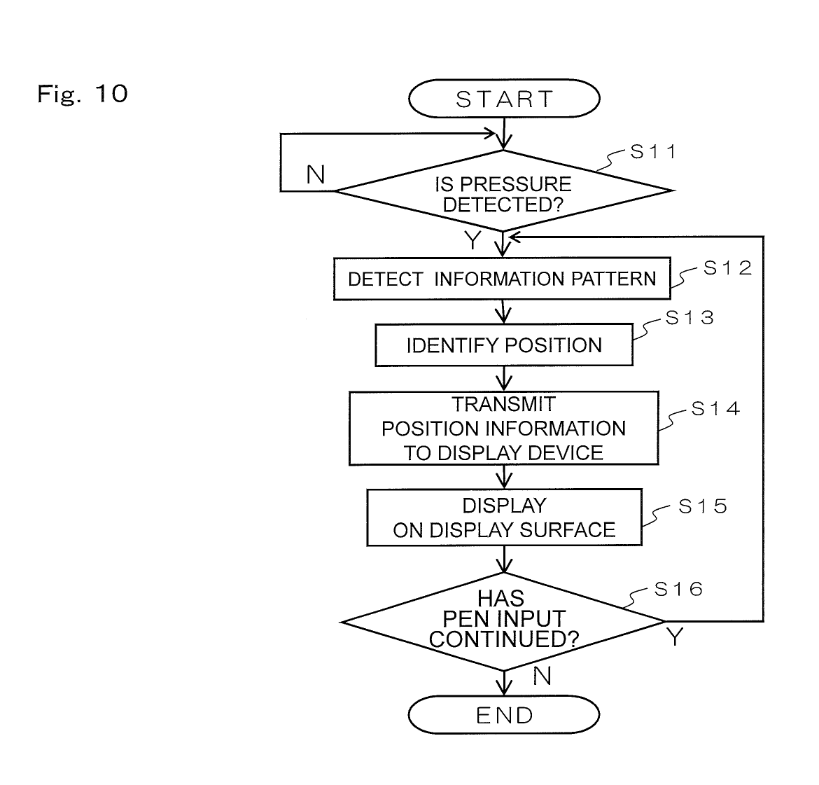

Subsequently, an operation of the display control system 100 configured as described above will be described. FIG. 10 is a flowchart showing flow of a process of the display control system 100. Hereinafter, a case will be described in which the user performs a pen input of (writes) a character on the display device 20 with the digital pen 10.

First, when the display control system 100 is powered on, the pen-side microcomputer 16b of the digital pen 10 starts monitoring a pressure applied to the pen tip portion 12 in step S11. The pressure detection is performed by the pressure sensor 13. When a pressure is detected by the pressure sensor 13 (Yes), the pen-side microcomputer 16b determines that the user is performing a pen input of a character on the display panel 24 of the display device 20, and the process proceeds to step S12. While no pressure is detected by the pressure sensor 13 (while No continues), the pen-side microcomputer 16b repeats step S11. It should be noted that when the digital pen 10 is powered on, the irradiation section 14 starts emitting infrared light. When a pressure is detected by the pressure sensor 13, infrared light may be emitted from the irradiation section 14.

In step S12, the reading section 15 of the digital pen 10 detects the information pattern 3 formed in the display panel 24. Here, the infrared light emitted from the irradiation section 14 is diffusely reflected on the above-described diffuse reflection sheet 48, and part of the infrared light returns to the digital pen 10 side. Then, almost no infrared light returning to the digital pen 10 side passes through the marks 31 of the information pattern 3. The infrared light having passed through the region between each mark 31 mainly reaches the objective lens 15a. Then, the infrared light is received by the image sensor 15b via the objective lens 15a. The objective lens 15a is arranged so as to receive reflected light from a position, on the display panel 24, which is pointed to by the pen tip portion 12. As a result, an image of the information pattern 3 at the position, on the display surface of the display panel 24, which is pointed to by the pen tip portion 12 is captured by the image sensor 15b. In this manner, the reading section 15 optically reads the information pattern 3. An image signal obtained by the reading section 15 is transmitted to the identification section 16a.

In step S13, the identification section 16a obtains the pattern shape of the information pattern 3 from the image signal, and identifies the position of the pen tip portion 12 on the display surface of the display panel 24 on the basis of the pattern shape. Specifically, the identification section 16a obtains the pattern shape of the information pattern 3 by performing determined image processing on the obtained image signal. Subsequently, the identification section 16a determines which pattern shape in a unit area 50 (unit area of 6 marks×6 marks) the pattern shape is, on the basis of the arrangement of the marks 31 in the obtained pattern shape, and identifies the position coordinate (position information) of the unit area 50 from the information pattern 3 in the unit area 50. The identification section 16a transforms the information pattern 3 to the position coordinate by determined calculation corresponding to the method for coding of the information pattern 3. The identified position information is transmitted to the pen-side microcomputer 16b.

Subsequently, in step S14, the pen-side microcomputer 16b transmits the position information to the display device 20 via the transmission section 17.

The position information transmitted from the digital pen 10 is received by the reception section 22 of the display device 20. The received position information is transmitted from the reception section 22 to the display-side microcomputer 23. In step S15, upon reception of the position information, the display-side microcomputer 23 controls the display panel 24 so as to change a displayed content at a position, on the display surface of the display panel 24, corresponding to the position information. In this example, because of character input, a spot is displayed at the position, on the display surface of the display panel 24, corresponding to the position information.

Subsequently, in step S16, the pen-side microcomputer 16b determines whether the pen input performed by the user has continued. When the pressure sensor 13 detects a pressure, the pen-side microcomputer 16b determines that the pen input performed by the user has continued, and the process returns to step S12. Then, by repeating a flow of steps S12 to S16, spots are continuously displayed at the position of the pen tip portion 12 on the display surface of the display panel 24 so as to follow movement of the pen tip portion 12 of the digital pen 10. At the end, a character corresponding to the trajectory of the pen tip portion 12 of the digital pen 10 is displayed on the display panel 24 of the display device 20.

On the other hand, in step S16, when the pressure sensor 13 detects no pressure, the pen-side microcomputer 16b determines that the pen input performed by the user has not continued, and the process is ended.

As described above, the display device 20 displays, on the display panel 24, the trajectory of the tip of the digital pen 10 on the display surface of the display panel 24. By so doing, it is possible to perform a handwriting input on the display panel 24 with the digital pen 10.

It should be noted that the case has been described above in which a character is written, but the use of the display control system 100 is not limited thereto. Needless to say, other than characters (numbers etc.), it is possible to write symbols, figures, and the like. In addition, it is also possible to delete a character, a figure, or the like displayed on the display panel 24 by using the digital pen 10 like an eraser. In other words, the display device 20 continuously deletes a display image at the position of the tip of the digital pen 10 on the display panel 24 so as to follow movement of the tip of the digital pen 10, whereby it is possible to delete the display image at the portion corresponding to the trajectory of the tip of the digital pen 10 on the display panel 24. Furthermore, it is also possible to move a cursor displayed on the display panel 24 or select an icon displayed on the display panel 24, by using the digital pen 10 like a mouse. In other words, it is also possible to operate a graphical user interface (GUI) by using the digital pen 10. As described above, in the display control system 100, an input to the display device 20 is performed in accordance with a position, on the display panel 24, which is pointed to by the digital pen 10, and the display device 20 performs various display control in accordance with the input.

### 7. Advantageous Effects of Embodiment

As described above, the display control system 100 of the present embodiment includes the display device 20 and the digital pen 10 that reads the information pattern 3 formed in the display device 20. The digital pen 10 includes: the at least one irradiation section 14 that emits light toward the display device 20; and the reading section 15 that captures an image of light reflected from the display device 20. The display device 20 includes: the optical film 40 in which the marks 31 are formed; and the diffuse reflection sheet 48 that is arranged at the back side of the optical film 40 and diffusely reflects the light from the irradiation section 14. The irradiation section 14 is spaced apart from the optical axis A of the reading section 15. Where the direction from the optical axis A toward the irradiation section 14 is defined as a first direction (X-axis positive direction), the point at which the central light beam Lc of the light emitted from the irradiation section 14 intersects the diffuse reflection sheet 48 is present at the first direction (X-axis positive direction) side of the point at which the optical axis A intersects the diffuse reflection sheet 48. In other words, in the perpendicular contact state where the optical axis A of the reading section 15 is perpendicular to the sheet surface of the diffuse reflection sheet 48 and the tip of the pen tip portion 12 of the digital pen 10 is in contact with the display panel 24, the point at which the central light beam Lc of the light emitted from the irradiation section 14 reaches the diffuse reflection sheet 48 is located at the irradiation section 14 side of the point at which the optical axis A of the reading section 15 intersects the diffuse reflection sheet 48.

Due to such a configuration, it is possible to suppress illumination unevenness in the imaging range W. As a result, it is possible to improve the accuracy of reading the information pattern 3.

In addition, in the perpendicular contact state, the main illumination range W′ on the diffuse reflection sheet 48 illuminated by the light beam having a light intensity equal to or higher than half of the maximum light intensity, of the light from the irradiation section 14, is wider than the imaging range W, on the panel surface 32a of the display panel 24, of the reading section 15. For example, when the display panel 24 is viewed from its front, the entire imaging range W is located within the main illumination range W′. Due to such a configuration, in the imaging range W, illumination unevenness is further reduced. Thus, the recognition rate of the information pattern 3 is high, and the coordinate detection rate is further increased accordingly.

### Other Embodiments

As described above, Embodiment 1 has been described as an illustrative example of the technology disclosed in the present application. However, the technology in the present disclosure is not limited thereto, and is also applicable to embodiments in which changes, substitutions, additions, omissions, and/or the like are made as appropriate. In addition, each constituent element described in the above Embodiment 1 can be combined to provide a new embodiment. Other embodiments will be described below.

Embodiment 1 has been described above with the liquid crystal display as an example of the display device, but the display device is not limited thereto. The display device 20 may be a device capable of displaying characters or video, such as a plasma display, an organic EL display, or an inorganic EL display. In addition, the display device 20 may be a device whose display surface is freely deformed, such as electronic paper.

In addition, the display device 20 may be a display of a notebook PC or a portable tablet. Furthermore, the display device 20 may be a television, an electronic whiteboard, or the like.

In Embodiment 1 described above, the optical film 40 in which the information patterns 3 are formed is arranged on the color filter 44, but the present disclosure is not limited thereto. The marks 31 may be formed directly on the color filter 44.

The digital pen 10 or the display device 20 may include a switching section that switches a process to be performed in accordance with an input of position information from the digital pen 10. Specifically, a switch may be provided in the digital pen 10 and may be configured to be switchable among input of characters or the like, deletion of characters or the like, movement of a cursor, selection of an icon, and the like. In addition, icons for switching among input of characters or the like, deletion of characters or the like, movement of a cursor, selection of an icon, and the like may be displayed on the display device 20 and may be selectable by using the digital pen 10. Furthermore, a switch corresponding to a right click or a left click of a mouse may be provided in the digital pen 10 or the display device 20. By so doing, it is possible to further improve the operability of the GUI.

The configurations of the digital pen 10 and the display device 20 of Embodiment 1 described above are examples, and the present disclosure is not limited thereto.

In Embodiment 1 described above, transmission and reception of signals between the digital pen 10 and the display device 20 are performed by means of wireless communication, but are not limited thereto. The digital pen 10 and the display device 20 may be connected to each other via a wire, and transmission and reception of signals may be performed via the wire therebetween.

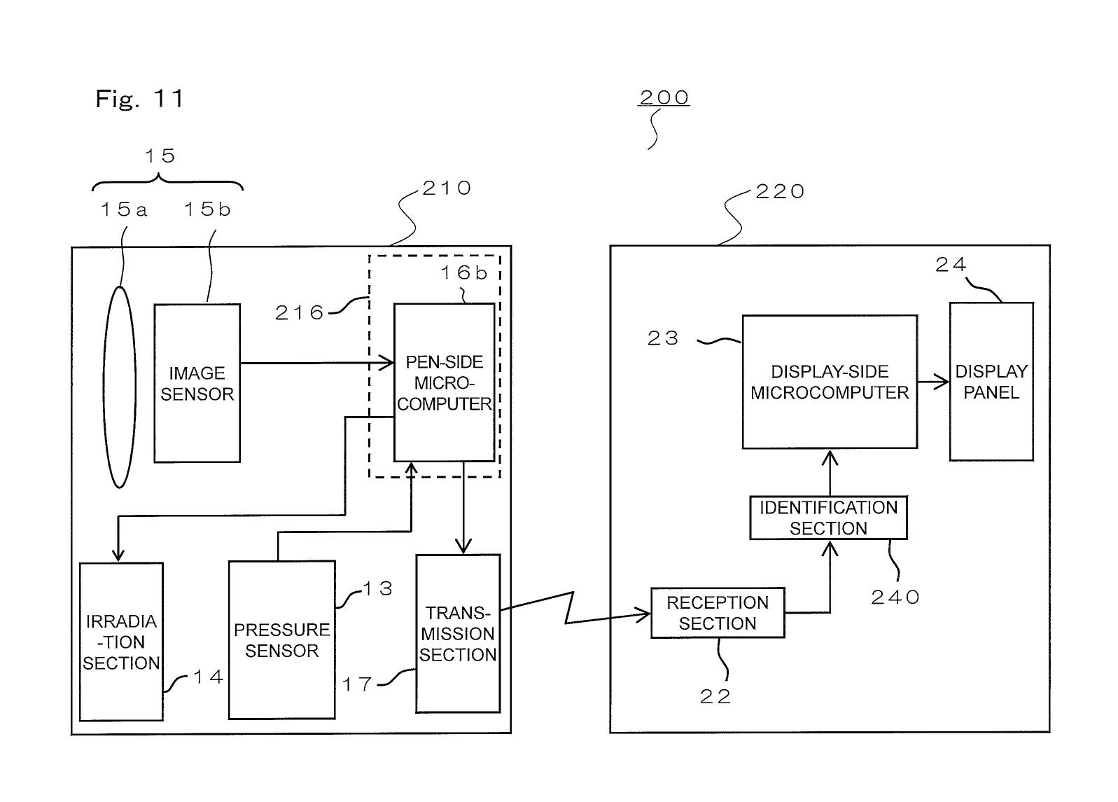

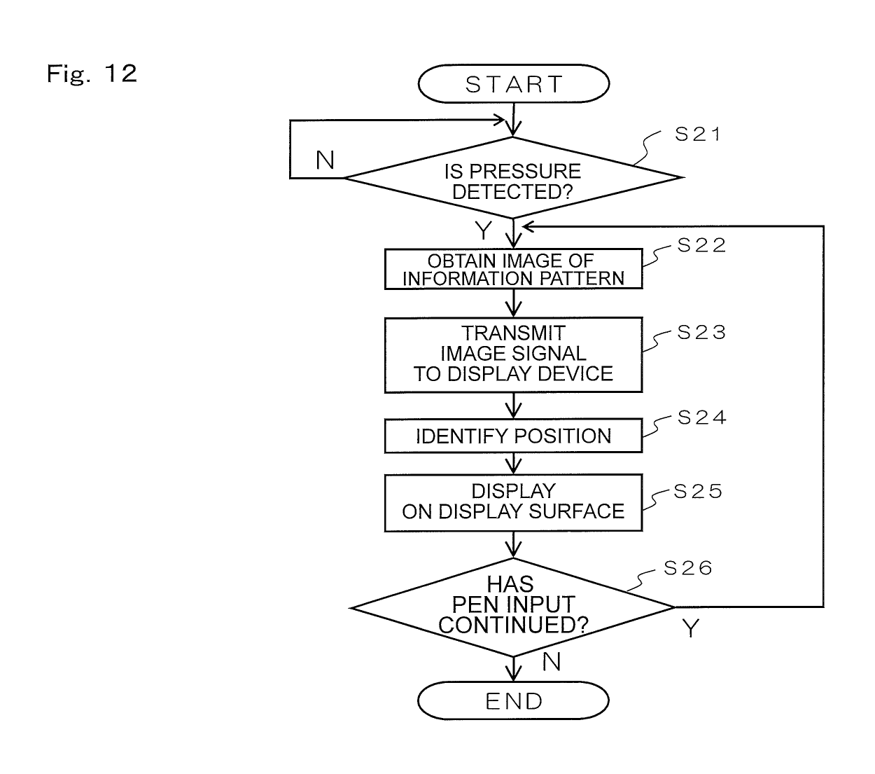

In Embodiment 1 described above, the digital pen 10 identifies position information and transmits the position information to the display device 20, but the present disclosure is not limited thereto. FIG. 11 is a block diagram of a display control system 200 according to another embodiment. A digital pen 210 shown in FIG. 11 includes a pressure sensor 13, an irradiation section 14, a reading section 15, a control section 216, and a transmission section 17. The configurations of the pressure sensor 13, the irradiation section 14, the reading section 15, and the transmission section 17 are the same as those in Embodiment 1 described above. The control section 216 includes a pen-side microcomputer 16b and does not include the identification section 16a in Embodiment 1. In other words, the control section 216 outputs an image signal inputted from an image sensor 15b, to the transmission section 17 without identifying position information of the digital pen 210 from the image signal. Thus, the image signal obtained by the image sensor 15b is transmitted from the digital pen 210. A display device 220 shown in FIG. 11 includes a reception section 22 that receives a signal from an external device, a display-side microcomputer 23 that controls the entirety of the display device 220, a display panel 24 that displays an image, and an identification section 240 that identifies the position of the digital pen 10. The configurations of the reception section 22, the display-side microcomputer 23, and the display panel 24 are the same as those in Embodiment 1. A plurality of information patterns 3 are formed in the display panel 24. The reception section 22 receives an image signal transmitted from the digital pen 210 and transmits the received image signal to the identification section 240. The identification section 240 has the same function as that of the identification section 16a of the digital pen 10 in Embodiment 1 described above. With this configuration, as shown in FIG. 12, the digital pen 210 obtains an image of the information pattern 3 with the image sensor 15b (step S22), and the image signal is transmitted from the digital pen 210 to the display device 220 (step S23). Then, the identification section 240 of the display device 220 identifies the position of the digital pen 210 from the image signal received from the digital pen 210 (step S24). The other processes are the same as in Embodiment 1 described above.

It should be noted that in the digital pen 210 of the display control system 200, after an image of the information pattern 3 is obtained, image processing may be performed to reduce an amount of data, and then a signal resulting from the image processing may be transmitted to the display device 220. In other words, as long as the digital pen 10 or 210 captures an image of the information pattern 3 representing information regarding a position, on the display panel 24, which is pointed to by the digital pen 10 or 210, information regarding the position on the display panel 24 may be transmitted in any form from the digital pen 10 or 210 to the display device 20 or 220. The display device 20 or 220 performs various display control in accordance with the received information regarding the position.

The identification section that identifies the position of the digital pen on the display panel 24 may be provided as a control device independent of the digital pen 10 and the display device 20. For example, in a display control system in which a digital pen is added to a desktop PC including a display (an example of a display device) and a PC body (an example of a control device), information patterns 3 may be formed in a display panel of the display. The digital pen optically may read the information pattern 3 and may transmit the information pattern 3 to the PC body. Then, the PC body may identify the position of the digital pen from the information pattern 3 and may instruct the display to perform a process corresponding to the identified position.

In Embodiment 1 described above, the pressure sensor 13 is used only for determining whether a pressure is applied, but the present disclosure is not limited thereto. For example, the magnitude of a pressure may be detected on the basis of a detection result of the pressure sensor 13. By so doing, it is possible to read continuous change in the pressure. As a result, on the basis of the magnitude of the pressure, it is possible to change the thickness or the color density of a line to be displayed through a pen input.

In Embodiment 1 described above, presence/absence of an input with the digital pen 10 is detected with the pressure sensor 13, but the present disclosure is not limited thereto. A switch that switches between ON and OFF of a pen input may be provided in the digital pen 10, and when the switch is turned ON, it may be determined that a pen input is present. In such a case, even when the digital pen 10 is not in contact with the surface of the display panel 24, it is possible to perform a pen input. Alternatively, the display device 20 may vibrate the display surface of the display panel 24 at a determined vibration frequency. In such a case, the display device 20 may be configured to detect presence/absence of a pen input by detecting a change in the vibration frequency that is caused by contact of the digital pen 10 with the display surface of the display panel 24.

In Embodiment 1 described above, each sub-pixel is rectangular, but is not limited thereto. Each sub-pixel may have a shape such as a triangle or a parallelogram, or may have a shape obtained by combining them. Each sub-pixel may have any shape as long as the display device is able to output characters or video. In addition, the black matrix may be changed as appropriate in accordance with the shape of each sub-pixel.

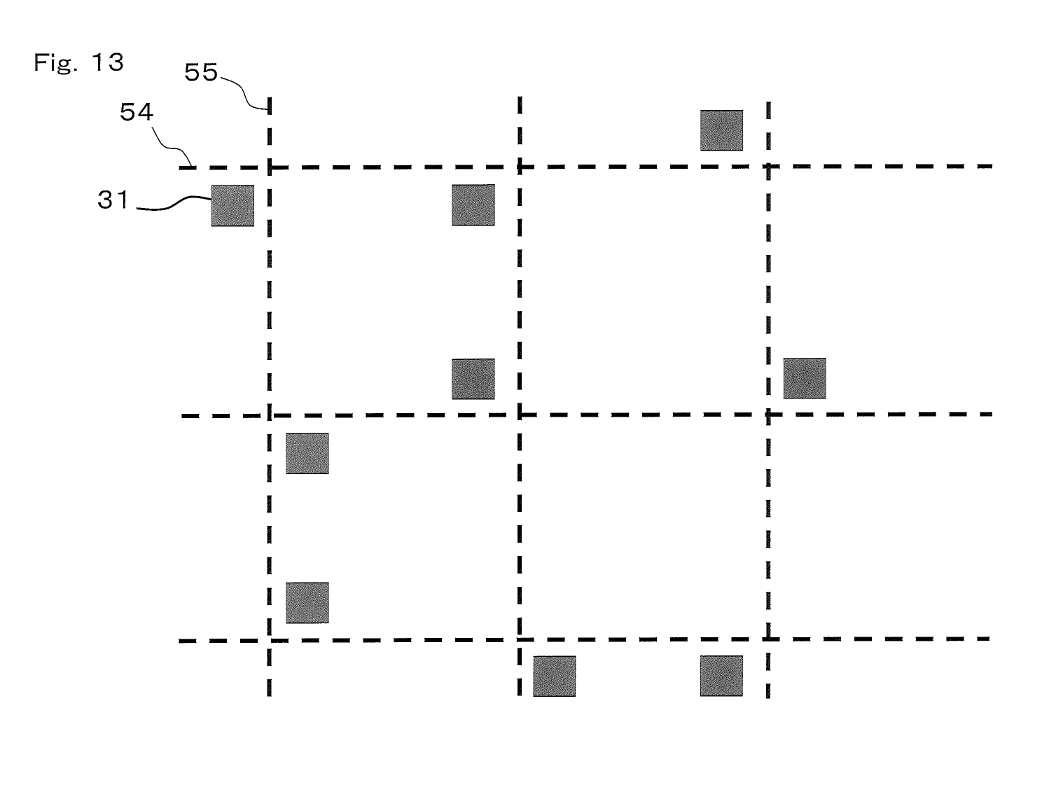

In Embodiment 1 described above, each mark 31 is arranged on the first reference line 54 or the second reference line 55. However, as shown in FIG. 13, each mark 31 may be arranged at a position shifted from the intersection of the first reference line 54 and the second reference line 55 in an oblique direction with respect to the first reference line 54 and the second reference line 55.

The arrangement pattern of each mark 31 is not limited thereto. Any method may be used for coding of each information pattern 3, and thus the arrangement pattern of each mark 31 may be changed in accordance with the used coding method.

The first reference lines 54 and the second reference lines 44 for arranging the marks 31 are not limited to Embodiment 1. For example, the first reference lines 54 may be defined on the black matrix 45 or may be defined on the sub-pixels. Furthermore, it is possible to arbitrarily select what color of pixel regions the first reference lines 54 are defined on. The same applies to the second reference lines 55.

In Embodiment 1 described above, each information pattern 3 is formed in a unit area 50 of 6 marks×6 marks, but is not limited thereto. The number of the marks 31 constituting a unit area may be set as appropriate in accordance with the designs of the digital pen 10 and the display device 20. In addition, the configuration of each information pattern 3 is not limited to a combination of the arrangements of marks 31 included in a determined area. The coding method is not limited to that in Embodiment 1 described above as long as each information pattern 3 is able to represent specific position information.

In Embodiment 1 described above, each information pattern 3 is composed of rectangular marks 31, but is not limited thereto. Each information pattern 3 may be composed of marks represented by figures such as triangles or characters such alphabets, instead of the rectangular marks 31. For example, each mark 31 may be formed over the entirety of the sub-pixel.

The identification section 16a transforms the information pattern 3 to a position coordinate by calculation, but the present disclosure is not limited thereto. For example, the identification section 16a may previously store all information patterns 3 and position coordinates associated with the respective information patterns 3 and may identify a position coordinate by checking an obtained information pattern 3 against the relationships between the stored information patterns 3 and position coordinates.

As presented above, the embodiments have been described as an example of the technology according to the present disclosure. For this purpose, the accompanying drawings and the detailed description are provided.

Therefore, components in the accompanying drawings and the detail description may include not only components essential for solving problems, but also components that are provided to illustrate the above described technology and are not essential for solving problems. Therefore, such inessential components should not be readily construed as being essential based on the fact that such inessential components are shown in the accompanying drawings or mentioned in the detailed description.

Further, the above described embodiments have been described to exemplify the technology according to the present disclosure, and therefore, various modifications, replacements, additions, and omissions may be made within the scope of the claims and the scope of the equivalents thereof.

What is claimed is:

1. A display control system comprising:
a display panel configured to display an image; and
a reading device configured to optically read an information pattern formed in the display panel, wherein
the reading device includes:
at least one light source configured to emit light toward the display panel; and
an imaging optical system configured to capture an image of the light that has been emitted from the light source and reflected by the display panel,
the display panel includes:
an information pattern layer in which the information pattern is formed; and
a reflection layer arranged at a back side of the information pattern layer and configured to diffusely reflect the light from the light source,
the light source is arranged at a position other than a position on an optical axis of the imaging optical system, and
in a perpendicular contact state where the optical axis of the imaging optical system is perpendicular to the reflection layer and the reading device is in contact with the display panel, a point at which a central light beam of the light emitted from the light source reaches the reflection layer is located at the light source side of a point at which the optical axis of the imaging optical system intersects the reflection layer.

2. The display control system according to claim 1, wherein in the perpendicular contact state, a main illumination range on the reflection layer illuminated by light beams having a light intensity equal to or higher than half of a maximum light intensity, of the light from the light source, is wider than an imaging range, on a surface of the display panel, of the imaging optical system.

3. A reading device for optically reading an information pattern in a display panel including: an information pattern layer in which the information pattern is formed; and a reflection layer arranged at a back side of the information pattern layer and configured to diffusely reflect light, the reading device comprising:
at least one light source configured to emit light toward the display panel; and
an imaging optical system configured to capture an image of the light that has been emitted from the light source and reflected by the display panel, wherein
the light source is arranged at a position other than a position on an optical axis of the imaging optical system, and
in a state where the optical axis of the imaging optical system is perpendicular to the reflection layer and the reading device is in contact with the display panel, a point at which a central light beam of the light emitted from the light source reaches the reflection layer is located at the light source side of a point at which the optical axis of the imaging optical system intersects the reflection layer.
